(19) United States
(12) Patent Application Publication
(10) Pub. No.: US 2026/0196859 A1
(43) Pub. Date: Jul. 9, 2026

(54) SYSTEMS AND METHODS FOR A BATTERY CHARGE SIGNAL OVER USB-C CABLES

(71) Applicant: Iontra Inc, Centennial, CO (US)

(72) Inventors: John Richard HOWLETT, III, Centennial, CO (US); Jace Hunter Hall, Aurora, CO (US); Matthew Triche, Aurora, CO (US)

(21) Appl. No.: 19/441,582

(22) Filed: Jan. 6, 2026

Related U.S. Application Data
(60) Provisional application No. 63/742,395, filed on Jan. 6, 2025.

(51) Int. Cl. H02J 7/90; H02J 7/06; H02J 7/42; H02J 7/47; H02J 7/80

(52) U.S. Cl. CPC H02J 7/927; H02J 7/42; H02J 7/80; H02J 7/933; H02J 7/06; H02J 7/47; H02J 2207/20; H02J 2207/30

(57) ABSTRACT

Methods and systems are disclosed for charging a battery utilizing a negotiable power supply in which a source device providing the negotiated power signal and a sink device negotiate the signal. The sink device includes a controller to request a shaped power signal from the source device. More particularly, the source device may receive a power signal from a power source, such as a wall outlet and convert the power signal into a requested negotiated power signal. During the communication between the devices, the sink device may provide one or more parameters of a negotiated power signal. In response, the source device may control a power converter circuit to convert the power signal received from the power source into a shaped negotiated power signal that includes the parameter. In general, the negotiated power signal may take any shape as requested by the sink device.

### CROSS-REFERENCE TO RELATED APPLICATIONS

This application is related to and claims priority under 35 U.S.C. § 119(e) from U.S. Provisional Ser. No. 63/742,395 , filed Jan. 6, 2025, entitled “Battery Charge Signal Over USBC Cables,” the entire contents of which is fully incorporated by reference herein.

### TECHNICAL FIELD

Embodiments of the present invention generally relate to systems and methods for charging of one or more batteries, and more specifically to a method of charging a battery where a charging signal is generated following a negotiation process between a source device and a sink device. The negotiation process may also include input from a cable electrically coupling the source device and the sink device.

### BACKGROUND AND INTRODUCTION

Many electrically powered devices, such as power tools, vacuums, any number of different portable electronic devices including mobile phones, tablets, watches and the like use rechargeable batteries as a source of operating power. Rechargeable batteries are limited by finite battery capacity and must be recharged upon depletion. Recharging a battery may be inconvenient as the powered device must often be stationary during the time required for recharging the battery. As such, significant effort has been put into developing charging technology that reduces the time needed to recharge the battery.

Battery systems also tend to degrade over time based on the charge and discharge cycling of the battery system, the depth of discharge and overcharging, among other possible factors. Thus, like the speed of charging, efforts are made to optimize charging to maximize battery life, not overdischarge the battery or overcharge the battery while using as much of the battery capacity as possible. Often these objectives are at odds, and charging systems are designed to optimize some attributes at the expense of others.

In some charging scenarios, pulse charging has been explored. However, it has been discovered that applying a square-wave pulse charge signal to charge a battery may degrade the life of the battery or may introduce inefficiencies in the charging of the battery. For example, the abrupt application of charge current (e.g., the sharp leading edge of a square-wave pulse) to the electrode (typically the anode) of the battery may cause a large initial impedance across the battery terminals resulting in a loss of transfer of power to the battery, lessening the efficiency of the charging process and/or damaging portions of the battery under charge, among other problems.

Rapid changes in the charge signal experienced from square pulses to the battery may introduce noise comprised of high-frequency harmonics, such as at the sharp leading edge of the square-wave pulse and during use of conventional reverse pulse schemes. Such high harmonics result in a large impedance at the battery electrodes. This high impedance may result in many inefficiencies and degradation of the battery, including capacity losses, heat generation, and imbalance in electro-kinetic activity throughout the battery, undesirable electro-chemical response at the charge boundary, and degradation to the materials within the battery that may damage the battery and degrade the life of the battery. Further, cold starting a battery with a sharp bonding edge pulse introduces limited faradaic activity as capacitive charging and diffusive processes set in. During this time, proximal lithium will react and be quickly consumed, leaving a period of unwanted side reactions and diffusion-limited conditions which negatively impact the health of the cell and its components. These and other inefficiencies are particularly detrimental during a fast recharging of the battery where relatively higher currents are often involved.

It is with these observations in mind, among others, that aspects of the present disclosure were conceived and developed.

### SUMMARY

One aspect of the present disclosure relates to a method of charging an electrochemical device. The method may include the operations of establishing a communication link between a source device and a sink device, the source device comprising a charging circuit for converting a power signal received from a power source to a negotiated power signal for the sink device and transmitting, from the sink device and to the source device and via the communication link, at least one characteristic of the negotiated power signal, the negotiated power signal comprising a harmonic associated with an operational characteristic of the electrochemical device. The method may further include receiving a battery characteristic feedback information from a battery measurement circuit, altering, based on the feedback information, the at least one characteristic of the negotiated power signal, and transmitting, from the sink device and to the source device and via the communication link, the altered at least one characteristic of the negotiated power signal.

Another aspect of the present disclosure relates to an electronic device comprising a battery, a communication interface for connection with a source device comprising a charging circuit for converting a power signal received from a power source to a negotiated power signal for charging the battery, and a controller in communication with the source device via the communication interface. The controller may be configured to transmit, to the source device, at least one characteristic of the negotiated power signal, the negotiated power signal comprising a harmonic associated with an operational characteristic of the battery, receive a battery characteristic feedback information from a battery measurement circuit, alter, based on the feedback information, the at least one characteristic of the negotiated power signal, and transmit, to the source device, the altered at least one characteristic of the negotiated power signal.

Yet another aspect of the present disclosure relates to a system for charging an electrochemical device comprising a power source, a power-converting source device in electrical communication with the power source to receive a power signal, the source device comprising a charging circuit for converting the power signal received from the power source to a negotiated power signal, and a sink device comprising a battery and in communication with the source device. The sink device may comprise a controller to transmit, to the source device, at least one characteristic of the negotiated power signal, the negotiated power signal comprising a harmonic associated with an operational characteristic of the battery, receive a battery characteristic feedback information from a battery measurement circuit, alter, based on the feedback information, the at least one characteristic of the negotiated power signal, and transmit, to the source device, the altered at least one characteristic of the negotiated power signal.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a schematic diagram illustrating a circuit for charging a battery utilizing a charge signal shaping circuit in accordance with one embodiment.

FIG. 2 is a signal graph of an example harmonically tuned charge waveform for charging a battery in accordance with one embodiment.

FIG. 3 is a schematic diagram illustrating a circuit for charging a battery utilizing switching elements to shape a charge signal in accordance with one embodiment.

FIG. 4 is a flowchart illustrating a method for utilizing a circuit model to determine a charge signal for charging a battery in accordance with one embodiment.

FIG. 5 is a block diagram of a system having a source device, a sink device, and a cable, where the system is configured to negotiate a charging signal and the source device is configured to generate the charging signal and deliver the charging signal to the sink device via the cable, in accordance with one embodiment.

FIG. 6 is an example waveform-based charge signal having active periods and rest periods, where the active periods include a shaped leading edge and a body portion, in accordance with one embodiment.

FIG. 7 is a flowchart illustrating a method for a negotiation process that may be performed to determine a charging signal for a sink device in accordance with one embodiment.

FIG. 8 is a diagram illustrating an example of a computing system which may be used in implementing embodiments of the present disclosure.

### DETAILED DESCRIPTION

Systems, circuits, and methods are disclosed herein for charging (recharging) one or more batteries. The terms charging and recharging are used synonymously herein. Aspects of the present disclosure may provide several advantages, alone or in combination, relative to conventional charging. For example, through the systems, circuits, and methods discussed, less energy may be required to charge a battery than through other conventional charging circuits and methods. In another example, the charging techniques described herein may reduce the rate at which an electrode (anode and/or cathode) is damaged or otherwise degraded as compared to conventional charge and discharge cycles, may reduce heat generated during charging, which may have several follow-on effects such as reducing electrode and cell damage, reducing fire or short circuit risks, and the like. In other examples, the charging techniques described herein may allow for higher charging rates to be applied to a battery and may thus allow for relatively faster charging as compared to other techniques, particularly when considered in conjunction with other advantages. The techniques may more generally optimize charge rates to be used, which optimization may consider charge rate as well as other issues such as cycle life and temperature. In one example, charge rates and parameters may be optimized to provide for a longer battery life and greater charging energy efficiency. In another example, in what might be considered “fast charging,” the disclosed systems and methods provide an improved balance of charge rate and battery life, while producing less heat.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different type of batteries ranging from an individual cell to batteries involving different possible interconnections of cells such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead acid batteries, various types of nickel batteries, and solid state batteries, to name a few. The various implementations discussed herein may also apply to different structural battery arrangements such as button or “coin” type batteries, cylindrical cells, pouch cells, and prismatic cells.

In one example, the various embodiments discussed herein charge a battery by generating a harmonically tuned charge signal using a model of one or more components of a charge signal tuning circuit. In particular, a charge signal tuning algorithm may provide, to a circuit model, an expected or intended charge signal for charging a battery. The model may, based on the intended charge signal, output one or more control signals to switches or other components of the charge signal tuning circuit based on a modeling of the components of the charge signal tuning circuit. In some instances, the tuned charge signal may correspond to a harmonic (or harmonics) associated with an optimal transfer of energy based on a real and/or an imaginary value of the energy transfer of the battery. In this manner, the control signals to the components of the charge signal tuning circuit shape or more generally tune a charge signal based on a model of the components of the circuit rather than or in addition to feedback of measurements of the charge signal at the battery during charging, such as voltage and current. In some instances, this approach may be referred to as a “feed-forward” technique. The feed-forward technique of utilizing a model of the circuit to determine the control signals for defining a charge signal may provide several advantages including accuracy and speed of signal adjustment. Moreover, the arrangement may be operable with fewer components than other approaches thereby reducing costs, using less PCB real estate, among other advantages. Additionally, even when using feedback, slower systems may be used as faster feedback may not be required.

Practically speaking, in some instances it may be insufficient to rely solely on a model of a circuit without some type of feedback to adjust for model errors, periodically provide additional data to the model to alter its output, among other things. For example, during operation of the charge circuit, aspects of the battery under charge may change in response to the state of charge (SoC), state of health (SoH), and the like. Thus, in some instances, aspects of the battery may be obtained and used to adjust the model of the circuit or control of the switches of the charging circuit to fine tune the shape of the charge signal. In general, modeling of the circuit provides an estimation and predetermination of charge signals to counter the relative slow feedback path from the battery sensors, particularly here where the presence of the model provides for techniques where less expensive slower feedback paths may be used. For example, the circuit model may be utilized to generate an initial shaped charge signal for the battery. However, the charge signal shape may be occasionally updated or adjusted based with feedback information based on measured or determined changes of the battery. In such instances, a very fast feedback path may be necessary as immediate real-time feedback may not be necessary. In some instances, such updates or changes in the circuit model and/or the shape of the charge signal may also provide an indication of a SoC and/or SoH of the battery being charged.

In another example, various embodiments discussed herein are suitable for charging a battery utilizing a negotiable power supply in which a source device providing the negotiated power signal and a sink device negotiate the signal. In one implementation, the sink device may include a controller to communicate with the source device to request a shaped power signal comprising a voltage and/or a current, which may then be provided by the source device. More particularly, the source device may receive a power signal from a power source, such as a wall outlet and convert the power signal into a requested negotiated power signal. A Universal Serial Bus Type-C (USB-C) is one type of negotiable power signal that may be used with the charge circuit embodiments described herein, although other negotiable power supply systems and associated connectors are also contemplated (e.g., SAE J1772-type connectors, other USB Power Delivery (PD) type connectors, etc.). During the communication between the devices, the sink device may provide one or more parameters of a negotiated power signal that may then be provided by the source device. For example, the sink device may provide an indication of a harmonic to the soured device. In response, the source device may control a power converter circuit to convert the power signal received from the power source into a negotiated power signal that includes the harmonic, perhaps to form a leading edge of the negotiated power signal. In general, the negotiated power signal may take any shape as requested by the sink device. Further, the sink device may alter the negotiated power signal “recipe” based on measurements or determinations of the state of the battery being charged. For example, the sink device may request a probe signal from the source device and, when received from the source device, apply the probe signal to the battery. During the application of the probe signal, the sink device may obtain one or more measurements of the battery and determine an alteration to the negotiated power supply in response to the obtained measurements. The sink device may then provide an updated power signal recipe to the source device, which may in turn control the converter to provide the altered power signal. In this manner, the sink device may request one or more waveform-based charge signals from the source device, based on the characteristics of the battery. In some instances, a model of the battery may also be used to determine the parameters of the negotiated charge signal, as discussed above.

These and other advantages gained through the use of a negotiable power supply are discussed in more detail herein.

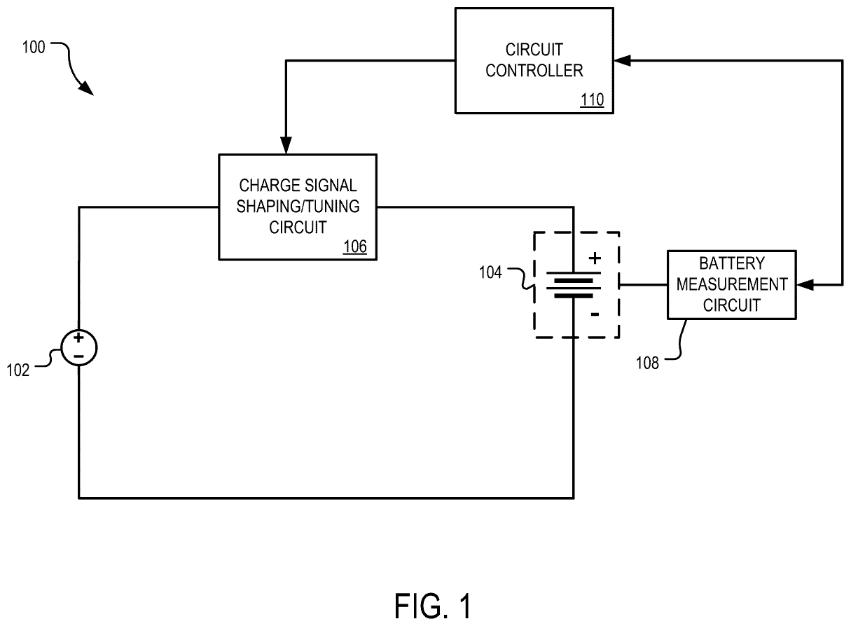

FIG. 1 is a schematic diagram illustrating an example circuit 100 for recharging a battery 104 utilizing a charge signal shaping circuit 106. In general, the circuit 100 may include a power source 102, which may be a voltage source, a current source, or a combination of voltage and current sources. In one particular embodiment, the power source 102 is a direct current (DC) voltage source, although alternating current (AC) sources are also contemplated. In various examples, the power source 102 may include a DC source providing a unidirectional current, an AC source providing a bidirectional current, or a power source providing a ripple current (such as an AC signal with a DC bias to cause the current to be unidirectional). In still other implementations discussed in more detail below, the power source 102 may be a negotiable power supply in which a voltage and maximum current from the power source may be negotiated between the power supply and one or more components of the charge circuit 100, such as circuit controller 110. In general, the power source 102 supplies the charge current that may be shaped and used to charge the battery 104. In one particular implementation, the circuit 100 of FIG. 1 may include a charge signal shaping circuit 106 to shape one or more aspects of a charge signal for use in charging the battery 104. In one example, a circuit controller 110 may provide one or more inputs to the power signal shaping circuit 106 to control the shaping of the charge signal. The inputs may be used by the shaping circuit 106 to alter a signal from the power source 102 into a more efficient power charging signal for the battery 104. The operation and composition of the charge signal shaping circuit 106 is described in more detail below.

In some instances, the charge signal shaping circuit 106 may alter energy from the power source 102 to generate a charge signal that is shaped based on charge conditions at the battery 104, such as a charge signal that at least partially corresponds to a harmonic or harmonics based on the impedance when a signal comprising the signal is applied to the battery 104. In one example, the circuit 100 may include a battery measurement circuit 108 connected to the battery 104 to measure battery voltage and/or charge current, as well as other battery attributes like temperature, and/or measure or calculate the impedance across the electrodes of the battery 104. In one example, battery characteristics may be measured based on the applied charge signal. In another example, battery characteristics may be measured as part of a routine that applies a signal with varying frequency attributes to generate a range of battery characteristic values associated with the different frequency attributes to characterize the battery, which may be done prior to charging, during charging, periodically during charging, and may be used in combination with look-up techniques, and other techniques. In one example, the system may include a look-up table that is generated based on testing of specific types of battery cells, and where the look-up table defines impedance values based on measured voltage and current values, which may also include phase offset information between the signal responses, from an applied charge signal with some known frequency attribute, whether a harmonic frequency profile of a leading edge of a charge pulse or otherwise. The table may also be organized also by temperature, SOC, or SOH. The battery 104 characteristics may vary based on many physical of chemical features of the battery, including a state of charge and/or a temperature of the battery. As such, the battery measurement circuit 108 may be controlled by the circuit controller 110 to determine various battery characteristic values during battery charging, among other times, and provide the measured and/or calculated battery values to the circuit controller 110.

Based on the battery characteristics, the circuit controller 110 may generate an intended charge signal for optimal battery charging. For example, impedance at a particular harmonic or harmonics may be used by the circuit controller 110 to define a charge signal that includes features of the particular harmonic or harmonics. As such, the circuit controller 110 may execute a charge signal algorithm that outputs a charge signal shape based on measured and/or modeling conditions of the battery 104. The circuit controller 110 may then generate one or more control signals based on the charge signal algorithm and provide those control signals to the charge signal shaping circuit 106. The control signals may, among other functions, shape the charge signal to approximate the shaped charge signal determined by the algorithm. The shaped charge signal will typically not conform to a traditional repeating charge signal, such as a repeating square wave or triangle wave charge signal.

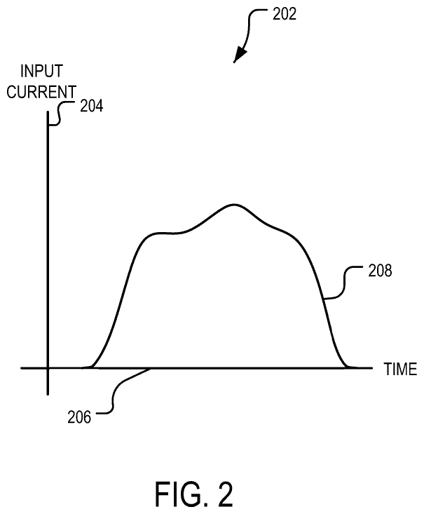

For example, FIG. 2 is a signal diagram 202 of a harmonically tuned battery charging signal 200 for charging a battery 104. The signal diagram 202 illustrates a charge signal 208 graphed as input current 204 versus time 206. The shape of the charge signal 208 may be determined by a charge signal algorithm or program executed by circuit controller 110. In one instance, the shape of the charge signal 208 may be based on characteristics of the battery 104, such as a correlation between impedance (real and/or imagining values thereof) and harmonic or frequency attributes of a signal applied to the battery, although other battery characteristics are contemplated. For example, the shape of some portion of the charge pulse 208 may correspond to a harmonic associated with the impedance value of the battery. In still another example, the charge signal 208 may correspond to a harmonic associated with one or both of a conductance or susceptance of an admittance of the battery 104. In other various embodiments, a charge signal for a battery cell may be altered to remove harmonics corresponding to a high impedance or conversely low admittance of the battery cell. As such, other measures may also be used, such as admittance or its components of susceptance and conductance with impedance being used in the discussed examples. The term impedance as used herein may include its inverse admittance. In general, the charge signal shaping algorithm of the circuit controller 110 may sculpt or otherwise determine the shape and/or tune the charge signal 208 based on any characteristics of the battery 104, either measured, modeled, or estimated. In the example of FIG. 2, the leading edge of the signal 208 may conform with a harmonic and the harmonic determined based on its impedance effect when applied to the battery for charge. The body of the signal may be comprised of various possible harmonics, which would be measurable upon application of various possible transforms, with the harmonic content of the body determined, at least in part, on the response impedance effect of one or more of the harmonics when applied during charge. The shape of the body may similarly contribute its own effect when applied to the battery. The width of the body may be on the order of microseconds but may also be significantly longer and range from milliseconds to seconds, or longer. The trailing edge of the charge signal may also conform to a harmonic. Various harmonic attributes of the charge signal may be defined alone or in various combinations.

Further, as the characteristics of the battery 104 may change due to state of charge, state of health, temperature, and other factors, the shape of the charge signal 208 may also be changed over time as the impedance response to the shape of the charge signal may change. The circuit controller 110 may therefore, in some instances, perform an iterative process of monitoring or determining characteristics of the battery 104 and adjust the shape of the charge signal 208 applied to the battery accordingly. In such a process, the model may be consulted, impedance at various frequencies computed and applied to the model or other shaping controller, among other things. This iterative process may improve the efficiency of the charge signal used to recharge the battery, thereby decreasing the time to recharge the battery, extending the life of the battery (e.g., the number of charge and discharge cycles it may experience), optimizing the amount of current charging the battery, and avoiding energy lost to various inefficiencies, among other advantages. One particular implementation of the charge shaping circuit 106 is further described in co-filed U.S. patent application Ser. No. 17/232,975 titled “Systems And Methods For Battery Charging” and filed on Apr. 16, 2021, the entirety of which is incorporated by reference herein.

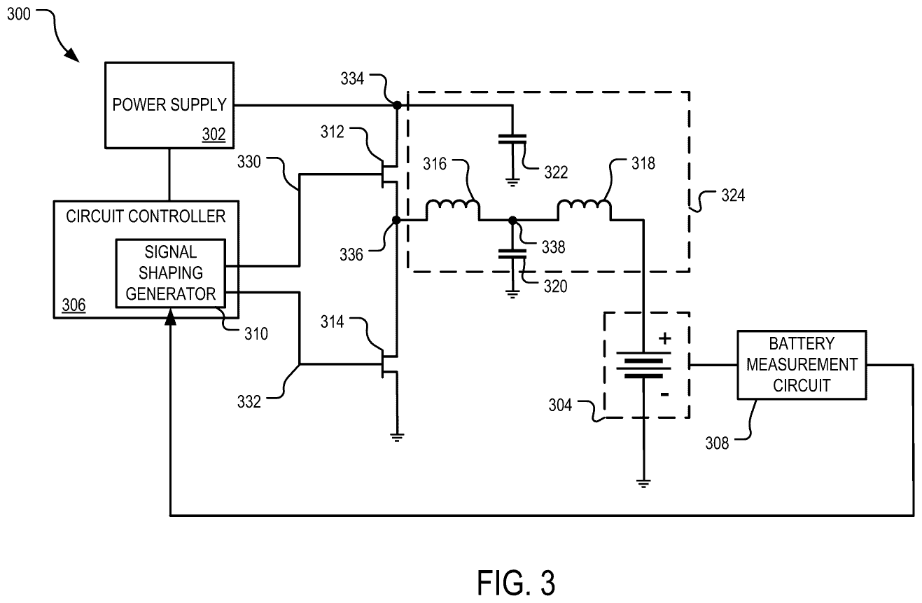

FIG. 3 is a schematic diagram illustrating a circuit 300 for charging a battery 104 utilizing switching elements 312, 314 to shape a charge signal for charging the battery, in accordance with one embodiment. The circuit 300 includes elements described above with reference to charging circuit 100 of FIG. 1, including power supply 302, circuit controller 306, battery measurement circuit 308, and battery 304. Other elements illustrated in the circuit 300 of FIG. 3 may be included in charge signal shaping circuit 106 of FIG. 1. Thus, as explained in more detail below, the circuit controller 306 may provide one or more control signals 330, 332 to elements of the circuit 300 to shape a current or voltage signal from the power supply 302 to charge the battery 304. The circuit controller 306 may be implemented through a Field Programmable Gate Array (FPGA) device, a microcontroller, an Application-Specific Integrated Circuit (ASIC), or any other programmable processing device. In one implementation, the circuit controller 306 may include a charge signal shaping generator 310 to determine the shape of the charge signal to be applied to the battery 304. The charge signal shaping generator 310 of the circuit controller 306, in some instances, receive measurements of characteristics of the battery from the battery measurement circuit 308 for use in determining the shape of the charge signal. However, as explained in more detail below, such a feedback mechanism may occur at a rate that does not allow for effective shaping of the charge signal such that a model of one or more components of the circuit 300 may be utilized to determine the control signals 330, 332 for controlling the elements of the circuit 300 with or without a feedback mechanism.

As mentioned, the circuit 300 may include one or more components to shape a charge signal for charging a battery 304. In the particular implementation shown, the circuit 300 may include a first switching element, e.g., transistor 312, and a second switching element, e.g., transistor 314, connected in series to an output 334 of the power supply 302. The first transistor 312 may receive an input signal, such as pulse-width modulation (PWM) control signal 330, to operate the first transistor 312 as a switching device or component. In general, the first transistor 312 may be any type of transistor, e.g., a FET, or any type of controllable switching element for controllably connecting a first inductor 316 to the output 334 of the power supply 302. For example, the first transistor 312 may be a FET with a drain node connected to the first inductor 316, a source connected to the power supply 302, and a gate receiving the control signal 330 from the circuit controller. The control signal 330 may be provided by the circuit controller 306 to control the operation of the first transistor 312 as a switch that, when closed, connects the first inductor 316 to the power supply 302 such that the charge signal from the power supply flows through the first inductor 316. The second transistor 314 may receive a second input signal 332 and may also be connected to the drain of the first transistor 312 at node 336. In some instances, the second input signal 332 may be a PWM signal opposite of the first control signal 330 to the first transistor 312. Thus, when the first transistor 312 is closed to connect the first inductor 316 to the power supply 302, the second transistor 314 is open. When the first transistor 312 is open, conversely, the second transistor 314 is closed, connecting node 336 and the first inductor 316 to ground. Although the first control signal 330 and the second control signal 332 are described herein as opposing signals to control the transistors into opposing states, other techniques for controlling the switching elements 312, 314 may also be implemented with the circuit 300. In general, the PWM signals 330, 332 are configured such that the first transistor 312 and the second transistor 314 may be open at the same time, but are not closed at the same time. The inductor value, the capacitor value, the time and frequency of actuating the transistors, and other factors can be tailored to generate a waveform and particularly a waveform with controlled harmonics to the battery for charging the same.

In addition to the first inductor 316, other components may be included in the circuit 300, collectively referred to as a “filter” 324 portion of the circuit. In particular, the circuit 300 may include a first capacitor 322 connected between the output 334 of the power supply and ground. A second capacitor 320 may be connected between the first inductor 316 (at node 338) and ground. A second inductor 318 may be connected between node 338 and an anode of the battery 304. The filter 324 of the circuit 300 may operate, in general, to prevent rapid changes to the charge signal applied to the battery 304. For example, upon closing of the first transistor 312 based on control signal 330, first inductor 316 and second inductor 318 may prevent a rapid increase in current transmitted to the battery 304. Such rapid increase in current and/or voltage may damage the battery 304 or otherwise be detrimental to the life of the battery. Moreover, the inductor may shape the waveform applied to the battery, and control of the signal applied to the inductor may provide for controlled shaping of the waveform. In essence, when the transistor is turned on connecting the inductor to the rail 334, the voltage at the input to the inductor rises but the inductor, depending on the inductor value, causes the leading edge of the charge current transferal from the inductor to be shaped and not abrupt. Depending on the inductor value and signal applied to the inductor, the shape may be controlled by controlling application of current and voltage to the inductor. In another example, capacitor 320 may store energy from the power supply 302 while first transistor 312 is closed. Upon opening of the first transistor 312, the capacitor 320 may provide a stable voltage to the inductor 318 such that the inductor may provide a predictable current to the battery 304 and may similarly be used to controllably shape the waveform applied to the battery. Other advantages for charging of the battery 304 are also realized through filter circuit 324 but are not discussed herein for brevity.

It should be appreciated that more or fewer components may be included in charge circuit 300. For example, one or more of the components of the filter circuit 324 may be removed or altered as desired to filter the charge signal to the battery 304. Many other types of components and/or configurations of components may also be included or associated with the charge circuit 300. Rather, the circuit 300 of FIG. 3 is but one example of a battery charging circuit 300 and the techniques described herein for utilizing a circuit model for generating or otherwise determining control signals 330, 332 for shaping a charge signal may apply to any number of battery charging circuits.

As described above, the signal shaping generator 310 of the circuit controller 306 may control the shape of the charge signal based on feedback measurements of the battery 304 received from the battery measurement circuit 308. For example, an initial charge signal may be applied to the battery 304 and one or more measurements of the battery 304 (such as a current into battery or a voltage across the battery) may be obtained by the battery measurement circuit 308. These measurements may be provided to the signal shaping generator 310 which may, in turn, determine an error between an expected measurement of the battery characteristic and a measured value at the battery 304. Based on this determined error, the signal shaping generator 310 may control, via control signals 330, 332, the first transistor 312 and the second transistor 314 to adjust the shape of the charge signal to the battery 304. In other words, the signal shaping generator 310 may sculpt the charge signal transmitted to the battery 304 to generate an expected measured characteristic of the battery 304. As long as the feedback measurements are expected, the shape of the charge signal may be maintained by the signal shaping generator 310 via the control signals 330, 332. A detected difference between an expected measurement and a measured value, however, may cause the circuit controller 306 to alter the shape of the charge signal to bring the battery 304 response into an expected range of values. For example, the circuit controller 306 may alter the shape of the charge signal based on an expected real impedance value or other characteristic of the battery. Some particular implementations for obtaining characteristic measurements of the battery are described in greater detail in co-filed United States Nonprovisional patent application Ser. No. 17/327,416 titled “Systems And Methods For Impedance Measurement Of A Battery Cell” and filed on May 21, 2021, the entirety of which is incorporated by reference herein.

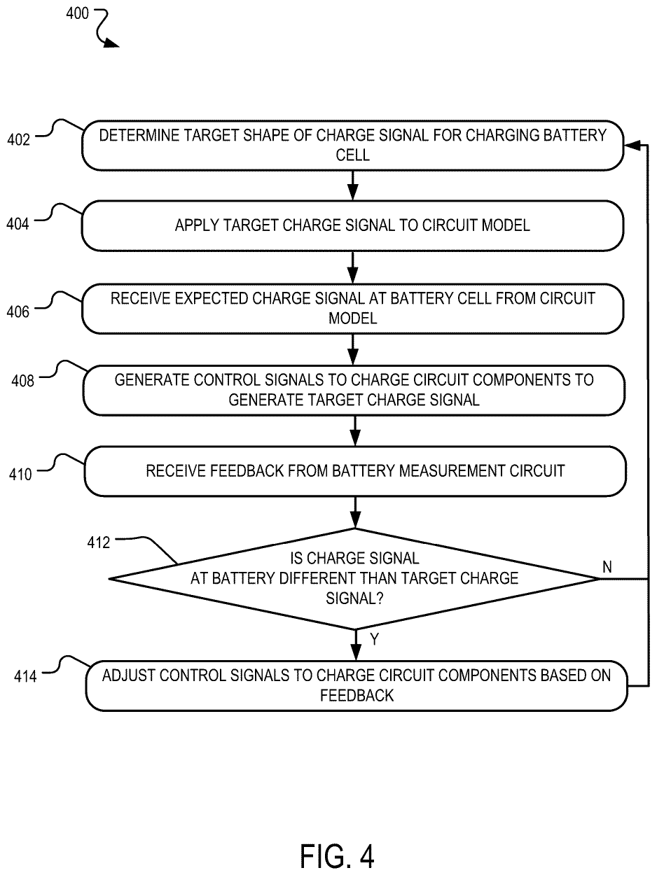

FIG. 4 is a flowchart illustrating a method 400 for utilizing a circuit model to determine a charge signal for charging a battery in accordance with one embodiment. The operations of the method 400 of FIG. 4 may be executed or performed by modules, programs, algorithms, components, etc. of the circuit controller 306 discussed above to shape a charge signal to charge a battery 304. In one instance, the circuit controller 306 may perform one or more of the operations to control the first transistor 312 and/or the second transistor 314 to shape the charge signal from a power supply 302 and apply the signal to charge the battery 304. In other instances, however, the circuit controller 306 may perform the method 400 or operations of the method to control any charge circuit components to shape or otherwise alter a charge signal to a battery 304. The operations may be performed by one or more hardware components of the circuit controller 306, one or more programs of the controller, or a combination of both hardware and software components of the circuit controller.

Beginning in operation 402, the circuit controller 306 may determine a target shape of a charge signal for charging a battery 304. As described above, the target shape for the charge signal may be based on characteristics of the battery 304 under charge, such as a measured impedance (including real and imaginary components), a state of charge, a battery temperature, a modeled ideal battery, etc. The shape of the charge signal may be any arbitrary shape, which may be formed by one or more specific harmonics. The charge signal may extend for some period of time and may temporarily drop to a zero or negative level before returning to a positive value. In various examples, the target shape of the charge signal may be generated by the signal shaping generator 310 of the circuit controller 306 based on a charge signal algorithm or any other executable instructions to determine a target shape of a charge signal for optimal charging of the battery 304.

In operation 404, the target charge signal may be applied to or otherwise provided to a model of the charge circuit 300. The circuit model may include a model of any number of components of the charge circuit 300 or any other charge circuit. In one particular implementation, the circuit model may comprise inductor 316 of the charge circuit 300. In another implementation, the circuit model may include the components of filter circuit 324 of the charge circuit 300 of FIG. 3. Regardless of the components modeled, the circuit model may receive the target charge signal and, through a simulation of the transistor control and resulting signal applied to the modeled inductor, generate or otherwise model the expected charge signal to be applied to the battery. Thus, in operation 406, the circuit controller 306 may receive the expected charge signal at the battery 304 of the modeled circuit. For example, the circuit model may comprise the inductor 316 component of the charge circuit. A target charge signal may be input to the modeled inductor (such as through a modeled control of the switches 312, 314 to generate the target charge signal) and, based on a simulation of the target charge signal as the signal is transmitted through the modeled inductor, an expected charge signal at the output of the modeled inductor may be output by the circuit model. As the inductor 316 is directly connected to the battery 304, the expected charge signal may be the charge signal as applied to the battery 304 to charge the battery. For circuit models that include other or different components, the effect on the charge signal by each component may be modeled and an output of the charge signal arriving at the battery 304 may be determined. Regardless of the number and configuration of components modeled, the output of the model indicates the effect the components may have on an input charge signal such that an estimated charge signal at the battery 304 may be determined.

The circuit controller 306 may, in operation 408, generate one or more control signals to components of the charge circuit 300 to generate a shaped charge signal based on the output of the circuit model. In one particular implementation, the circuit controller 306 may generate one or more control signals to the first switching device 312 and/or the second switching device 314 to account for the effect the charge circuit 300 components may have on the charge signal such that the charge signal applied to the battery 304 takes the shape as determined by the signal shaping generator 310. For example, when a target charge signal shape is determined, the circuit controller 306 may generate control signal 330 for first transistor 312 and/or control signal 332 for second transistor 314. In one instance, control signal 330 may be opposite control signal 332 such that the switching of transistors occurs in opposite states (e.g., an open first transistor occurs at the same time as a closed second transistor and vice versa). In general, however, any control signals for any number of components of the charge circuit 300 may be generated and transmitted to the components of the charge circuit to generate the shaped charge signal for charging the battery 304. Regardless of how the charge circuit in controlled, the control signals may be based on an estimated charge signal at the battery 304. The use of the circuit model may be utilized to improve the efficiency and speed at which the charge signal is shaped.

At operation 410, the circuit controller 306 may receive feedback data from battery measurement circuit 308, which feedback may be characteristics of the battery 304 in response to the shaped target charge signal. Such signals may include a current into the battery or a voltage across the battery, among others, in response to or in the presence of a charge signal at the battery, which may be the initial charge signal. The measurements may be provided to the signal shaping generator 310 which may, in turn, determine an error between an expected measurement of the battery characteristic and a measured value at the battery 304. Thus, at operation 412, the circuit controller 306 determine a difference, or “error”, between expected measured values at the battery 304 from the shaped charge signal and the measured values at the battery. If the measured values at the battery 304 are not different than the expected values, the circuit controller 306 may return to operation 502 to repeat the above process. However, if the feedback indicates that the measured aspects at the battery 304 due to the shaped charge signal is different than an expected value as output by the circuit model 340, the one or more controls of the components of the circuit 300 may be adjusted based on the determined error in operation 414. In this manner, components of the circuit controller 306 may be altered or adjusted in response to the feedback received from the battery measurement circuit 308.

In addition, the charging circuits and methods described herein may apply to a battery 304 comprising a single cell or multiples. In a multiple cell configuration, the cells may be arranged in a series configuration, a parallel configuration, or a combination of series and parallel configurations. Multiple batteries arranged in a series configuration may reduce the overall current used to charge the batteries as the current is divided among batteries in the series connection. By connecting the batteries in series, the charging circuit 300 may require less current, further improving the efficiency of the charging circuit.

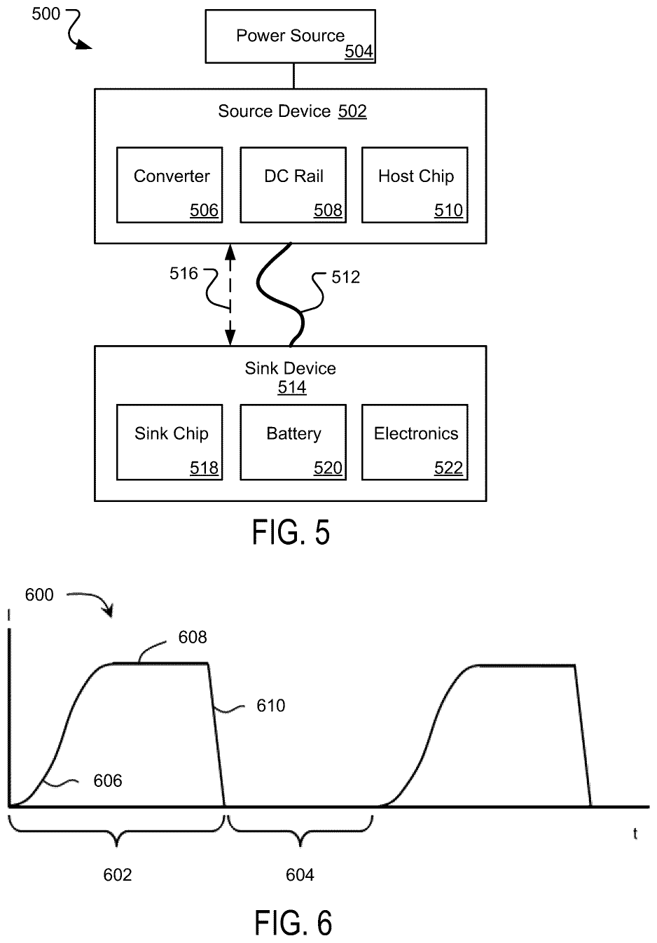

In some instances, the power supply of the battery charge circuit discussed above may include a negotiable power supply in which the supplied power signal (e.g., voltage and/or current signals that comprise the power signal) may be negotiated or otherwise selected by one or more components of the charge circuit such that the power signal may vary from charge to charge. FIG. 5 shows a system 500 that utilizes a negotiable power supply for charging a battery 520 of a sink device 514. More particularly, the sink device 514 may negotiate with a source device 502 receiving power from a power source 504 to receive a negotiated power signal from the source device. In general, the source device 502 is configured to electrically couple with an alternating current (AC) power source 504 to receive AC power from the power source. The source device 502 may include electronic circuitry 506 to convert the AC power from the power source 504 to direct current (DC) power or to otherwise alter the received power signal from the power source, such as increasing and/or decreasing the voltage and/or current of the received power signal. The converted power signal may be output to a DC rail 508 within the source device 502, in some instances. Further, a gateway or host chip 510 of the source device 502 may be configured to access the converted power from the DC rail 508 and to communicate with the sink device 514 using one or more communication protocols to provide the converted power signal to the sink device, as described in more detail below.

In general, a negotiable power supply is an interface through which a particular power signal may be requested or negotiated by a sink device 514 from a source device 502. In this manner, the source device 502 may alter the power signal received from the power source 504 into a power signal requested by the sink device 514. One or more aspects or components of the power signal may be negotiated by the sink device 514, such as a voltage component and/or a maximum current component of the power signal. One example of a negotiable power supply is a USB-C supply, although other types of negotiable power standards are contemplated with the systems and methods discussed herein. The power source 504 may be any power source, including but not limited to, a wall outlet, a charge block, a laptop computer, a battery, or any other source of a power signal. The amount of power available from the power source 504 may vary based on the type of power source. For example, a laptop computer may provide less charging power than a wall outlet, but either may be considered a source device 502. Thus, the source device 502 may provide an interface between the power source 504 and the sink device 514 that provides for different power signals provided to the sink device depending on the type of power signal requested. In the USB-C example above, the source device 502 may include a USB-C type connector that may interface with a wall power source 504 or a USB-C port in a laptop or other computing device from which power may be provided to the sink device 514. In this manner, the source device 502 may provide an interface to different power sources 504 providing different power signals for charging a battery 520 of the sink device 514.

The sink device 514 may be an electronic device such as a cell phone, tablet, wearable (e.g., headphones, hearing aids, etc.), e-reader, laptop computer, or any other electronic device. In some embodiments, the sink device 514 may be a battery-powered electronic device that includes a battery 520. The type and/or size of the sink device 514 and its power requirements and/or battery size may determine the type of advantage the sink device receives from systems and methods described herein. For example, devices with smaller batteries and/or power requirements may advantageously reach full charge in less time than would be required to fully charge the device using standard charging methods and equipment. These smaller devices may also receive the benefit of reduced battery deterioration over the course of a charge cycle, and thus, may benefit from increased battery lifespan (e.g., increased number of charge cycles and/or slower reduction of battery capacity over time). Sink devices 514 with larger batteries and/or power requirements may not necessarily receive fast-charging benefits but may benefit from the reduced battery deterioration improvements without increasing charging times (e.g., as compared to standard charging methods and equipment).

In some instances, a communication cable 512 is configured to electrically couple with the source device 502 at a first end and a sink device 514 at a second end. In some embodiments, the couplings may be via a USB connector, such as a USB-C type connector. The cable 512 may include a chip configured to communicate with one or more of the source device 502 and the sink device 514 during a negotiation process, which will be discussed in further detail below. The chip of the communication cable 512 may provide information about the type of cable and its maximum current, maximum voltage, maximum average current, maximum average voltage, and/or other specifications related to the cable's limiting factors in transferring a charging signal from the source device to the sink device. Regardless of the specifications of the cable, specifics of the power signal provided by the source device 502 may be negotiated through and limited by the communication cable 512 connecting the sink device to the source device.

As noted, the specific charging signal provided to the sink device 514 from the source device 502 may be determined using a negotiation process. Communication between the source device 502 and the sink device 514 may occur over cable 512 (e.g., as represented by dashed arrow 516 of FIG. 5). The communication may be from the source device 502 to the sink device 514 and vice versa. As described above, the sink device 514 is connected to the source device 502 over cable 512. Communication between the sink device 514 and the source device 502 occurs such that the sink device learns about the signal generation capabilities of the source device. As such, a signal for charging the battery 520 of the sink device 514 may be determined or selected through a negotiation process with the source device 502 over the cable 512 that includes input from the source device, the sink device, and/or the cable. The determined or selected charging signal is generated by the source device 502 and provided to the sink device 514 over the cable 512. The charging signal may have parameters specifically tailored to the sink device 514, its battery 520, and/or other on-board electronics 522 of the sink device and considers the capabilities of the connecting cable 512.

The sink device 514 may include one or more charging routines stored thereon and executed by sink chip 518 for charging the battery 520 of the device. In the case where multiple acceptable charging routines are stored on the sink device 514, the charging routines may be ordered by preference by the sink chip 518. For example, a preferred charging routine may be a fast-charge routine or a charging routine that minimizes battery degradation. A lower preference charging routine may be a conservative, slow speed charging routine. The specific charging signals and their order of preference may be dependent on the specific device type, battery, and application.

Similar to above, at least one of the charging signals of the sink device 514 may be a shaped charge signal as described above. One example of such a charge signal is illustrated in the graph of FIG. 6 illustrating a plot of a charge signal as charge current I versus time t. The charging signal 600 includes alternating active periods 602 and rest periods 604 that may be repeated over time t. The active periods 602 may be defined by application of a current to the battery 520 followed by rest periods 604 defined by a reduction in current to levels at or near zero. The active periods 602 may further be characterized by specific shapes and/or timing parameters. For example, active period 602 may include a shaped leading edge 606 followed by a constant body portion 608 and a falling edge 610. Following the falling edge 610, an “off” period 604 may be provided in which no current or a negative current may be provided to the battery 520. The shaped leading edge 606 may be a sinusoidal curve, an approximation of a sinusoidal curve achieved using linear segments, a stepwise increasing current, an increasing ramp, or other shape. The body period current value, body period duration 602, rest period current value, and rest period duration 604 may also be described in a charging signal routine. One or more of the current or timing parameters may be dependent upon battery state information determined by the sink device 514 and provided to the source device 502. Thus, the charging signal may be dynamic in nature and may include an alternating signal as illustrated in FIG. 6 and/or may include constant current and/or constant voltage portions.

The signal diagram 600 of FIG. 6 illustrates input current, in the case of a current controlled hardware circuit, versus time of pulses of a charge signal, although a similar shape may be applied to a voltage charge signal. As can be seen, each pulse of the charge signal 600 may be asymmetric with a leading edge 606 distinctly shaped relative to the trailing edge 610. The pulses (e.g., the leading edge and/or body) may be defined, in one example, by a combination of harmonics corresponding to or related to a minimum impedance value seen at the battery cell electrodes. In particular, the charge signal 600 may include a leading edge portion 606 that corresponds to a selected frequency that relates to the minimum impedance value for the battery 520 of the sink device 514. For example, the shape of the leading edge 606 may correspond to a harmonic identified by the control circuit included in the sink chip 518 of the sink device 514 as the frequency at a minimum real impedance value at the battery 520 of the sink device. In one example, the leading edge 606 shape may be based on the leading edge of a corresponding sinusoid at the frequency of minimum impedance. Identifying the minimum impedance frequency may be based on a measurement (or measurements), battery characterization, alone or in combination, among other things. Regardless of the selected frequency, the leading edge 606 of a pulse of the charge signal 600 may be the shaped to be the same as the leading edge of a portion of a sinusoidal charge signal at a harmonic that minimizes or reduces the impedance seen at the battery cell for a more efficient application of a power recharge signal.

Although discussed above in relation to real impedance values at the battery electrodes, the reactance or imaginary portion of the impedance at the battery electrodes may also be considered when shaping a charge signal. Other aspects, such as admittance values and/or susceptance values may also be considered. In one particular implementation, the pulse shape and overall period of the pulses of the charge signal 600 for recharging the battery 520 of the sink device 514 may be tailored to correspond to the imaginary component of impedance as well as the real component of the impedance. As such, some implementations of the circuits and methods described herein may optimize the frequency from which a pulse shape is defined, and the period of the overall charge signal applying such pulses, by accounting for both imaginary and real impedance to varying degrees, such as through understanding the frequencies of both components of the impedance at the battery cell. Still other implementations may use admittance values and/or susceptance values calculated from the measured real impedance and/or the measured imaginary impedance at the battery cell.

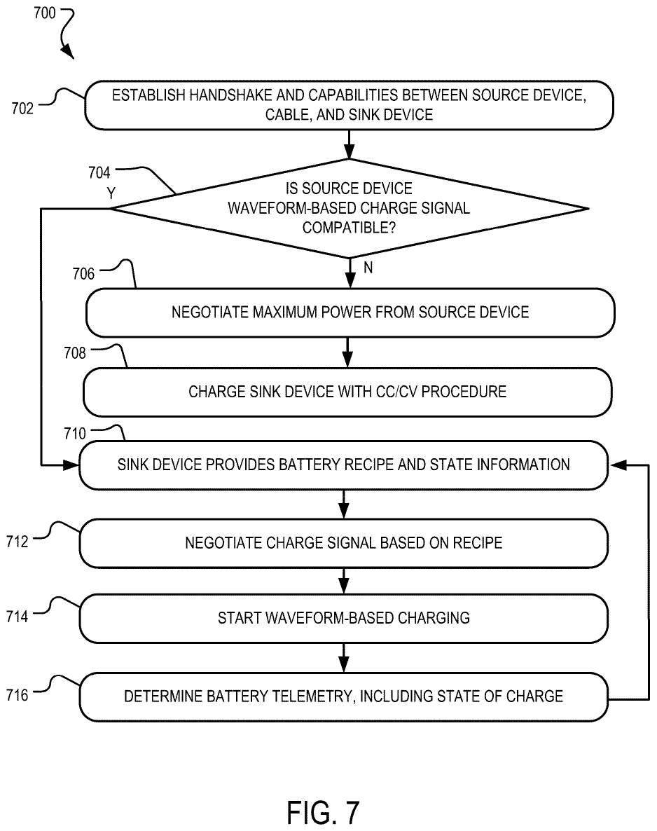

FIG. 7 is a flowchart illustrating a method 700 for a negotiation process that may be performed to determine a charging signal for the sink device 514 as provided by the source device 502. As such, aspects of the method 700 may be performed by the sink device 514 and/or the source device 502 discussed above. Communications may be transmitted between the sink device 514 and the source device 502 to accommodate the execution of one or more operations of the method 700. In general, any component or circuit described herein, including the host chip 510 of the source device 502 and/or the sink chip 518 of the sink device 514 may execute or otherwise perform aspects of the method 700.

At operation 702, handshake communications may be transferred between the sink device 514 and the source device 502 to establish a request for a power signal from the source device. In one particular example, the handshake communication may occur over a USB-C type cable 512, although other communication standards are contemplated. During the initial negotiation, several types of information may be exchanged or transmitted between the sink device 514 and the source device 502. For example, upon connection of the sink device 514 to the source device 502 by connecting the communication cable 512 between the devices, the sink device 514 may provide information about itself to the source device 502. Such information may include, among other information, information specific to the battery 520 of the sink device 514, such as battery chemistry, size, or other information. In some embodiments, the sink device 514 may further provide battery state information to the source device 502. Battery state information may include state of charge (SOC), state of health (SOH), battery voltage, or other battery-specific information. Such battery state information may be utilized by the source device 502 to properly provide or pause a charging signal and may be used by the sink device 514 and/or the source device 502 to monitor, adjust, start, or stop charging, as explained in more detail below.

Additional information may be transmitted between the source device 502 and the sink device 514, including device identifications and capabilities. In one instance, the additional information may include a request, from the sink device 514, for a waveform-based charge signal 600 similar to shown in FIG. 6 from the source device 502. Other waveform-based power signals with different shapes than those illustrated in FIG. 6 may also be requested. The source device 502 may respond with an authentication that that the source device 502 is capable of providing such a waveform-based signal to the sink device 514. In addition, the communication cable 512 may also provide an indication that the cable is capable of transmitting the requested waveform-based power signal. For example, following the exchange of initial information between the sink device 514 and the source device 502, the sink device may provide a desired charging routine to the source device. More particularly, the sink chip 518 may access a desired charging routine for charging the sink device 514 from a memory component (not shown) of the sink device. The sink chip 518 may modify and/or transmit the desired charging routine to the source device 502. The host chip 510 of the source device 502 may then compare the desired charging routine to one or more limiting factors of charging the battery 520 of the sink device. For example, in the case where the sink device 514 is a cell phone, the communications may indicate that the source device is rated for a maximum voltage of 5V and a maximum current of 3A. The source device 502 may compare this information with one or more specifications or limitations of the source device converter 506 and/or the power source 504 to determine if it is capable of delivering power according to the requested charging routine. In some embodiments, communication cable 512 information may also be considered in determining whether a requested signal may be provided.

At operation 704, it may be determined if the source device 502 can provide a waveform-based charging routine to the sink device 514 to charge the sink device battery 520 (for instances in which a waveform-based charging routine is requested). If the requested charging signal cannot be provided by the source device 502, a limiting factor (e.g., a cable amperage limit, source amperage limit, etc.) of providing the power signal is identified and may be used to determine a charge routine that can be provided by the source device 502 and cable 512 and acceptable to the sink device 514. In one instance, a maximum possible power signal from the source device 502 may be requested by the sink device 514 in operation 706. If the negotiation is successful, the source device 502, utilizing the converter 506 and rail 508, may convert a power signal from the power source 504 and provide the maximum possible power signal to the sink device 514. In addition, the power signal provided by the source device 502 may be utilized to charge the battery 520 of the sink device 514 through a constant current/constant voltage (CC/CV) charging procedure.

If the source device 502 is capable of providing a waveform-based charging signal, the sink device 514 may provide additional recipe information and/or battery state information in operation 710. For example, the requested waveform-based charging routine may include a charging signal comprising a repeating active and rest period similar to that described in relation to FIG. 6. The source device 502 may therefore include corresponding aspects or components to provide the requested power signal. In one particular example, the source device 502 may include aspects of the charging circuit 300 illustrated in FIG. 3 described above. For example, the converter 506 of the source device 502 may include the switching devices 312, 314 and/or the filter circuit 324 of the charging circuit. In this example, the power supply 302 of the converter 506 may be the power source 504 while the circuit controller/signal shaping generator may be included between the source device 502 and the sink device 514. More particularly, the converter 506 of the source device 502 may include a circuit controller that interprets the charging recipe or charge signal parameters into control signals 330, 332 for the switching devices 312, 314 to generate the requested waveform-based power signal. In general, however, the converter 506 of the source device 502 may include any circuit capable of converting a power signal from the power source 504 to a charging signal for the battery 520 of the sink device 514 corresponding to the requested power signal recipe provided to the source device.

As such, if the sink device 514 is able to receive such a waveform-based charging signal and the source device 502 is capable of providing the requested signal, additional information may be provided during the charge signal requesting and negotiating process at operation 712. For example, particular information of the requested charge signal 600 may be provided to the source device 502 from the sink device 514, such as information of the active periods 602 and rest periods 604, including the maximum current and/or voltage, the duration of the active periods and rest periods, duration of components of the active periods (such as the shaped leading edge 606 and the constant body portion 608), and/or any other information that may be needed to provide the requested waveform-based charging routine. Further, information concerning or defining the shaped leading edge 606 may also be provided, such as a sinusoidal curve of the leading edge, an approximation of a sinusoidal curve achieved using linear segments, a stepwise increasing current, an increasing ramp, or other shape information. The body period current value, body period duration 602, rest period current value, and rest period duration 604 may also be described in a charging signal routine.

In response to the transmission of the charge signal recipe, the source device 502 may begin providing a charging signal having the requested characteristics, including the specific charge signal information (e.g., current levels, timing parameters, etc.). More particularly, the source device 502 may utilize the converter 506, the DC rail 508, and/or the host chip 510 to convert a power signal received from the power source 504 that corresponds to the received charge signal recipe. As noted above, the converter 506 may include aspects of the charge circuit 300 discussed above, although other charge circuits are contemplated. Once provided, the sink device 514 may begin charging the battery 520 of the sink device with the requested charge signal in operation 714. In this manner, the sink device 514 may request a shaped charge waveform from the source device 502 for waveform-based charging of the sink battery 520.

In some embodiments, the charge signal for charging the battery 520 may be dynamic and dependent on state information of the battery. For example, the sink device 514 may also include software and/or hardware for measuring or calculating battery state information, similar to battery measurement circuit 308 of circuit 300. The battery measurement circuit 308 may provide measurements and/or calculations of the battery 520 to the sink chip 518 for storage and/or processing in operation 716. As described above, the charge signal for charging the battery 520 may be based on the battery measurements and/or calculations, such as the battery state of charge and/or state of health. In general, any measurement of the state of the battery may be utilized by the sink device 514 to determine an altered charge signal. In some instances, the sink chip 518 may access a stored charging recipe based on the received battery state and/or measurements.

In one particular example, the charging signal for the charging the battery 520 may be based on a state of charge or other aspect of the battery. For example, a high current or high voltage charge signal may be initially provided to the battery, but either or both the current and voltage may be reduced as the battery approaches a full state of charge. Regardless of the motivations, the charging signal may be dynamic such that some aspect of the charge signal may be adjusted over the charging time and based on a state or measurement of the battery. In such instances, the sink chip 518 of the sink device 514 may process the battery state or measurement to determine a new charge signal profile. In some instances, the sink device 514 may store a plurality of charge signal profiles for charging the battery 520 based on a determined state of the battery. Thus, the sink chip 518 may determine the charge signal to be requested based at least on the received measurements and/or battery states. In other instances, the sink chip 518 may determine an alteration to the charge signal based on the measurements and/or determined states of the battery 520.

In response to the determined alteration to the charge signal, the sink device 514 may generate and transmit an altered charge signal recipe to the source device 502 by returning to operation 710. The source device 502 may, in turn, apply the updated charge signal recipe to generate an adjusted charge signal to provide to the sink device 514. For example, the host chip 510 may control aspects of the converter 506 to convert a power signal from the power source 504 to generate the adjusted charge signal for providing to the sink device 514. The sink device 514 may, in turn, utilize the adjusted charge signal to charge the battery 520 based on the measurements and/or determined states of the battery being charged.

In some embodiments, the adjustment to the charge signal may comprise a probing signal utilized by the sink device 514 to determine the state of the battery 520. For example, the sink device 514 may, periodically or non-periodically, request a probe charge signal from the source device 502. The probe charge signal may be configured or designed to perturb the battery 520 such that one or more measurements of the battery may be obtained by the sink device 514. In this example, the source device 502 may adjust the generated charge signal based on the probe recipe provided by the sink device 514 such that measurements of the battery 520 may be obtained by the sink device. The probe signal may be requested to occur for a short time period in relation to the duration of the charge signal, but sufficient to allow for the sink device 514 to obtain the battery measurements. In response, the source device 502 may alter the power signal provided to the sink device 514 for application to the battery 520, at which time measurements of the state and/or operation of the battery may occur. Following transmission of the probe charge signal to the battery 520, the source device 502 may return to providing a charge signal for the battery 520 to the sink device 514. As described, the charge signal may be similar to that illustrated in FIG. 6, although other charge signals may be provided by the source device. In some instances, the charge signal generated by the source device 502 may be the same or similar to the charge signal that was provided prior to the probe signal. More particularly, the host chip 510 may control the converter 506 to generate the charge signal based on the last received charge signal recipe. In another example, the source device 502 may wait, following the probe signal, to receive a current charge signal recipe from the sink device 514 before transmitting another charge signal.

As described above, the battery measurements obtained based on the probe signal may be utilized by the sink device 514 to determine or adjust a charge signal recipe to transmit to the source device 502 for adjustment of the charge signal. In particular, the sink chip 518 may receive and process one or more measurements of the battery 520 of the sink device 514 and adjust the charge signal in response to the received measurements. For example, the sink chip 518 may adjust a harmonic of the charge signal 600 in response to a determined impedance of the battery 520, such as adjusting an aspect of the leading edge 606 of the charge signal in response to the determined impedance. Similar adjustments to the charge signal 600 may be executed based on other aspects of the battery, such as a current level and/or voltage level of the charge signal based on a determined impedance, reactance, state of charge, state of health, and the like of the battery 520. In general, the sink chip 518 may adjust any aspect of the charge signal in response to a determined measurement or state of the battery 520 of the sink device 514, based on the probe signal or a measurement taken during charging or discharging of the battery.

The sink chip 518 of the sink device 514 may also generate a new charge signal recipe for a new charge signal, either based on the battery measurements or some other change in the sink device. The new recipe may include the alteration to the charge signal, such as a higher or lower average current, higher or lower average voltage, or changes to the shape of the charge signal 600. The source device 502, and more particularly the host chip 510, may interpret or otherwise process the new recipe and control the converter 506 to provide the requested power signal based on the recipe to the DC rail 508 of the source device. In this manner, the sink device 514 may continually update the charge recipe and request an updated charge signal, including with altered charge signal shaping, from the source device 502 for optimal battery charging.

As noted above, the sink device 514 may communicate with the source device 502 to request the charge signal utilizing a USB-C cable 512 in one particular embodiment. Generally speaking, USB-C charging is governed by USB Power Delivery (USB-PD) specifications. As such, charge signals generated by the source device 502 and transmitted across the cable 512 may stay within the USB-PD specifications. A charge signal similar to that of signal 600 that has active portions and rest portions often has higher absolute current values (i.e., during the body portion 608) that a constant current/constant voltage charge signal would typically have. However, the average current of the signal 600 may be tailored such that it stays within limits defined by the USB-PD specifications (generally 5 Amps, although other specifications of the USB cable 512 are contemplated). In one instances, determining an absolute and average value limitations for currents and voltages for the charge signal may also be a step within the negotiation process between the source device 502 and the sink device 514. Such negotiations may include comparing the requested values or parameters of the charge signal to one or more USB-PD specifications.

In addition, driving a waveform-based charging signal over the USBC cable 512 may include specific considerations to be maintained within USB-PD specifications. For example, standard USB-C cables 512 lack dedicated wires that might be used to transmit voltage monitoring data (i.e., “VMON”) data from the sink device 514 to the source device 502. Traditionally, this has been done using an analog signal carried over a twisted pair of wires as a dedicated sense signal. However, this functionality is not supported by USBC cables 512. Instead, VMON data, along with other data, may be pre-processed within the sink device 514 and transmitted back to the source device 502 as a digital signal.

There are generally two options available for transmitting telemetry digitally using a USBC cable 512. In one instance, telemetry data may be transmitted over one or more Configuration Channel (CC) lines of the cable. These CC lines may be used to negotiate and configure the charge signal from the source device 502 to the sink device 514 via USB-PD capable devices. The protocol used on the CC lines is governed by the USB-PD specifications and generally supports special vendor defined messaging. However, there are concerns with data throughput and latency when attempting to transmit all necessary battery telemetry information to the source device 502. Thus, a second option may be used to overcome the noted throughput and latency concerns. In particular, the USB-PD standard includes special Sideband Use (SBU) lines which may be used in a number of different ways, including analog signaling for audio applications and digital data transfer. For example, I2C signals may be sent over the SBU lines to create a dedicated channel for the transfer of telemetry back to the source device. Such SBU lines may be utilized between the sink device 514 and the source device 502 to communicate the charge signal recipe and/or battery telemetry data to the source device to generate the requested charge signal.

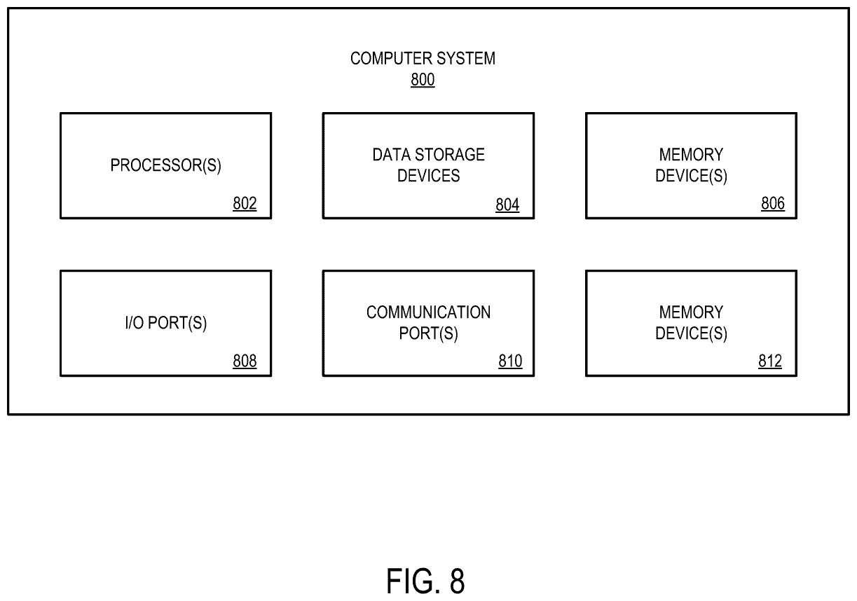

Referring now to FIG. 8, a detailed description of an example computing system 800 having one or more computing units that may implement various systems and methods discussed herein is provided. The computing system 800 may be part of a controller, may be in operable communication with various implementation discussed herein, may run various operations related to the method discussed herein, may run offline to process various data for characterizing a battery, and may be part of overall systems discussed herein. The computing system 800 may process various signals discussed herein and/or may provide various signals discussed herein. For example, battery measurement information may be provided to such a computing system 800. The computing system 800 may also be applicable to, for example, the controller, the model, the tuning/shaping circuits discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, Microcontroller, or other computing arrangement. In such various possible implementations, more or fewer components discussed below may be included, interconnections and other changes made, as will be understood by those of ordinary skill in the art.

The computer system 800 may be a computing system that is capable of executing a computer program product to execute a computer process. Data and program files may be input to the computer system 800, which reads the files and executes the programs therein. Some of the elements of the computer system 800 are shown in FIG. 8, including one or more hardware processors 802, one or more data storage devices 804, one or more memory devices 806, and/or one or more ports 808-812. Additionally, other elements that will be recognized by those skilled in the art may be included in the computing system 800 but are not explicitly depicted in FIG. 8 or discussed further herein. Various elements of the computer system 800 may communicate with one another by way of one or more communication buses, point-to-point communication paths, or other communication means not explicitly depicted in FIG. 8.

The processor 802 may include, for example, a central processing unit (CPU), a microprocessor, a microcontroller, a digital signal processor (DSP), and/or one or more internal levels of cache. There may be one or more processors 802, such that the processor 802 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 804, stored on the memory device(s) 806, and/or communicated via one or more of the ports 808-812, thereby transforming the computer system 800 in FIG. 8 to a special purpose machine for implementing the operations described herein. Examples of the computer system 800 includes or may be implemented in vehicles of various possible types ranging from scooters and bicycles to cars, power tools, various possible mobile communication/computing environment including mobile phones, tablets, and laptops, personal computers, multimedia consoles, gaming consoles, set top boxes, embedded computing and processing systems, and the like.

The one or more data storage devices 804 may include any non-transitory data storage device capable of storing data generated or employed within the computing system 800, such as computer executable instructions for performing a computer process, which may include instructions of both application programs and an operating system (OS) that manages the various components of the computing system 800. The data storage devices 804 may include, without limitation, magnetic disk drives, optical disk drives, solid state drives (SSDs), flash drives, and the like. The data storage devices 804 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 806 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 804 and/or the memory devices 806, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 800 includes one or more ports, such as an input/output (I/O) port 808, a communication port 810, and a sub-systems port 812, for communicating with other computing, network, or vehicle devices. It will be appreciated that the ports 808-812 may be combined or separate and that more or fewer ports may be included in the computer system 800. The I/O port 808 may be connected to an I/O device, or other device, by which information is input to or output from the computing system 800. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 800 via the I/O port 808. In some examples, such inputs may be distinct from the various system and method discussed with regard to the preceding figures. Similarly, the output devices may convert electrical signals received from computing system 800 via the I/O port 808 into signals that may be sensed or used by the various methods and system discussed herein. The input device may be an alphanumeric input device, including alphanumeric and other keys for communicating information and/or command selections to the processor 802 via the I/O port 808. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 800 via the I/O port 808. For example, an electrical signal generated within the computing system 800 may be converted to another type of signal, and/or vice-versa. In one implementation, the environment transducer devices sense characteristics or aspects of an environment local to or remote from the computing device 800, such as battery voltage, open circuit battery voltage, chare current, battery temperature, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 800, such as, physical movement of some object (e.g., a mechanical actuator), heating or cooling of a substance, adding a chemical substance, and/or the like.

In one implementation, a communication port 810 may be connected to a network by way of which the computer system 800 may receive network data useful in executing the methods and systems set out herein as well as transmitting information and network configuration changes determined thereby. For example, charging protocols may be updated, battery measurement or calculation data shared with external system, and the like. The communication port 810 connects the computer system 800 to one or more communication interface devices configured to transmit and/or receive information between the computing system 800 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 810 to communicate with one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 810 may communicate with an antenna for electromagnetic signal transmission and/or reception. In some examples, an antenna may be employed to receive Global Positioning System (GPS) data to facilitate determination of a location of a machine, vehicle, or another device.

The computer system 800 may include a sub-systems port 812 for communicating with one or more systems related to a device being charged according to the methods and system described herein to control an operation of the same and/or exchange information between the computer system 800 and one or more sub-systems of the device. Examples of such sub-systems of a vehicle, include, without limitation, motor controllers and systems, battery control systems, and others.

The system set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A method of charging an electrochemical device comprising:
establishing a communication link between a source device and a sink device, the source device comprising a charging circuit for converting a power signal received from a power source to a negotiated power signal for the sink device;
transmitting, from the sink device and to the source device and via the communication link, at least one characteristic of the negotiated power signal, the negotiated power signal comprising a harmonic associated with an operational characteristic of the electrochemical device;
receiving a battery characteristic feedback information from a battery measurement circuit;
altering, based on the feedback information, the at least one characteristic of the negotiated power signal; and
transmitting, from the sink device and to the source device and via the communication link, the altered at least one characteristic of the negotiated power signal.

2. The method of claim 1, wherein the communication link comprises a cable with a Universal Serial Bus, Type C (USB-C) connector in electrical communication between the sink device and the source device.

3. The method of claim 2, wherein the power source is at least one of a wall outlet, a charge block, or a laptop computer.

4. The method of claim 2, wherein the source device is constrained by a USB Power Delivery (USB-PD) configuration standard.

5. The method of claim 1, wherein the negotiated power signal comprises a harmonically shaped leading edge corresponding to the harmonic and wherein the operational characteristic of the electrochemical device is an impedance effect of the harmonic on the electrochemical device when charging.

6. The method of claim 1 further comprising:
transmitting, from the sink device and to the source device and via the communication link, a request for a battery probing signal; and
receiving the battery probing signal from the source device, wherein the battery characteristic feedback information is received from a battery measurement circuit in response to transmitting the battery probing signal to the electrochemical device.

7. The method of claim 1, wherein the at least one characteristic of the negotiated power signal comprises an average current value, an average voltage value, a peak current value, a peak voltage value, a charge pulse duration, or a rest duration.

8. The method of claim 1 further comprising:
transmitting, from the sink device to the source device and via the communication link, the battery characteristic feedback information, the negotiated power signal based at least on the battery characteristic feedback information.

9. The method of claim 1 further comprising:
obtaining, from a storage of the sink device, the at least one characteristic of the negotiated power signal prior to transmission of the at least one characteristic of the negotiated power signal to the source device.

10. An electronic device comprising:
a battery;
a communication interface for connection with a source device comprising a charging circuit for converting a power signal received from a power source to a negotiated power signal for charging the battery; and
a controller in communication with the source device via the communication interface to:
transmit, to the source device, at least one characteristic of the negotiated power signal, the negotiated power signal comprising a harmonic associated with an operational characteristic of the battery;
receive a battery characteristic feedback information from a battery measurement circuit;
alter, based on the feedback information, the at least one characteristic of the negotiated power signal; and
transmit, to the source device, the altered at least one characteristic of the negotiated power signal.

11. The electronic device of claim 10, wherein the communication comprises an interface for a Universal Serial Bus, Type C (USB-C) connector.

12. The electronic device of claim 11, wherein the power source is at least one of a wall outlet, a charge block, or a laptop computer.

13. The electronic device of claim 11, wherein the source device is constrained by a USB Power Delivery (USB-PD) configuration standard.

14. The electronic device of claim 10 further comprising:
at least one circuit powered by a power signal generated by the battery.

15. The electronic device of claim 10, wherein the negotiated power signal comprises a harmonically shaped leading edge corresponding to the harmonic and wherein the operational characteristic of the battery is an impedance effect of the harmonic on the battery when charging.

16. The electronic device of claim 10, wherein the at least one characteristic of the negotiated power signal comprises an average current value, an average voltage value, a peak current value, a peak voltage value, a charge pulse duration, or a rest duration.

17. The electronic device of claim 10, wherein the controller further transmits, to the source device and via the communication interface, the battery characteristic feedback information, the negotiated power signal based at least on the battery characteristic feedback information.

18. A system for charging an electrochemical device comprising:
a power source;
a power-converting source device in electrical communication with the power source to receive a power signal, the source device comprising a charging circuit for converting the power signal received from the power source to a negotiated power signal; and
a sink device comprising a battery and in communication with the source device, the sink device comprising a controller to:
transmit, to the source device, at least one characteristic of the negotiated power signal, the negotiated power signal comprising a harmonic associated with an operational characteristic of the battery;
receive a battery characteristic feedback information from a battery measurement circuit;
alter, based on the feedback information, the at least one characteristic of the negotiated power signal; and
transmit, to the source device, the altered at least one characteristic of the negotiated power signal.

19. The system of claim 18 further comprising a cable with a Universal Serial Bus, Type C (USB-C) connector, the cable in in electrical communication between the sink device and the source device.

20. The system of claim 18, wherein the power source is at least one of a wall outlet, a charge block, or a laptop computer.

21. The system of claim 18, wherein the negotiated power signal comprises a harmonically shaped leading edge corresponding to the harmonic and wherein the operational characteristic of the electrochemical device is an impedance effect of the harmonic on the electrochemical device when charging.
